(19) United States
(12) Patent Application Publication
(10) Pub. No.: US 2025/0034968 A1
(43) Pub. Date: Jan. 30, 2025

(54) LEARNING MACHINE FOR SUBSURFACE SAFETY VALVE

(71) Applicant: Landmark Graphics Corporation, Houston, TX (US)

(72) Inventors: Bilal Hungund, Bangalore (IN); Rahul Saraf, Bangalore (IN)

(21) Appl. No.: 18/360,406

(22) Filed: Jul. 27, 2023

(51) Int. Cl. E21B 34/10; E21B 34/16

(52) U.S. Cl. CPC E21B 34/10; E21B 34/16; E21B 2200/22

(57) ABSTRACT

Some implementations include a method for predicting closure of a subsurface safety valve (SCSSV) configured to shut-in a well without any sensors on the SCSSV. The method may include obtaining, by a learning machine, sensor readings indicating downhole conditions in the well. The method may include predicting, by the learning machine, closure of the SCSSV based on the sensor readings indicating downhole conditions in the well. The method may include transmitting a communication predicting closure of the SCSSV.

### TECHNICAL FIELD

The disclosure generally relates to the field of subsurface wells, and more specifically to determining subsurface safety value systems.

### BACKGROUND

Gas fields and upstream well heads may include subsurface safety valves within the wellbore. The main intention behind installing a subsurface safety valve (SCSSV) at each well is to shut-in the well if integrity of the well or surface is lost. The subsurface safety valve may be controlled through a surface control line which may be attached to the outside of the tubing string, and it manages the hydraulic line. The subsurface safety value may open if hydraulically pressured at a given pressure but may close in absence of the requisite hydraulic depressurized.

One problem with such subsurface safety valves is they may close automatically based on conditions in the well. An automatic SCSSV closure may lead to a shut-in of the well. Restarting production and achieving normal production levels may take significant time, thereby causing production delays.

### BRIEF DESCRIPTION OF THE DRAWINGS

Implementations of the disclosure may be better understood by referencing the accompanying drawings.

FIG. 1 is a block diagram illustrating an example production environment.

FIG. 2 is a block diagram representing an example fluid network for a well.

FIG. 3 is a process diagram showing an example process for training and utilizing a learning machine to control an SCSSV in a wellbore.

FIG. 4 is a graph illustrating labeled sensor samples.

FIG. 5 is a chart showing parameters and their relationship to an SCSSV closure.

FIG. 6 is a conceptual diagram showing an example neural network.

FIG. 7 is a block diagram illustrating a computer system, according to some implementations.

FIG. 8 is a flow diagram illustrating a method for predicting closure of an SCSSV.

### DESCRIPTION OF IMPLEMENTATIONS

The description that follows includes example systems, methods, techniques, and program flows that embody implementations of the disclosure. However, this disclosure may be practiced without these specific details. For clarity, some well-known instruction instances, protocols, structures, and techniques may not be shown in detail.

### Overview of Some Implementations

Wells often include safety systems that turn-off production after detecting unsafe conditions. For example, a control system may include a surface controlled subsurface safety valve (SCSSV) configured to turn-off production if unsafe conditions are detected. For example, if the control system detects unusually high pressure in the well, the control system may close the SCSSV to protect surface equipment by containing the high preserve in the well. In response, well operators may take measures to ensure well safety and then restart production. In some cases, closure of the SCSSV can be avoided with early detection of conditions that lead to the automatic closure of the SCSSV. Well operators are incentivized to avoid SCSSV closures to maintain production rates and to avoid difficulties associated with bringing wells back into production mode after an SCSSV closure.

Some implementations may train and then utilize a learning machine to predict SCSSV closures before they occur. To train the learning machine, some implementations may collect sensor samples captured by sensors in the well. The sensor samples may indicate conditions in the well, such as flow rates, pressures, temperatures, and other conditions. The sensor samples may be labeled to form a training data set, where the labels indicate normal well behavior, pre-shut-in behavior, shut-in behavior, and restart behavior. The learning machine may process the training data set to learn patterns in the sensor samples that lead to automatic closure of the SCSSV. After the learning machine is trained, it may be deployed in a well to monitor well sensors and notify operators of potential closures to the SCSSV, such as by detecting well conditions that may lead to an SCSSV closure. For example, the learning machine may monitor sensor readings from the well and make predictions (based on well conditions) about when an SCSSV closure may occur (such as in an hour). The learning machine also may notify operators about the predictions.

### Some Example Implementations

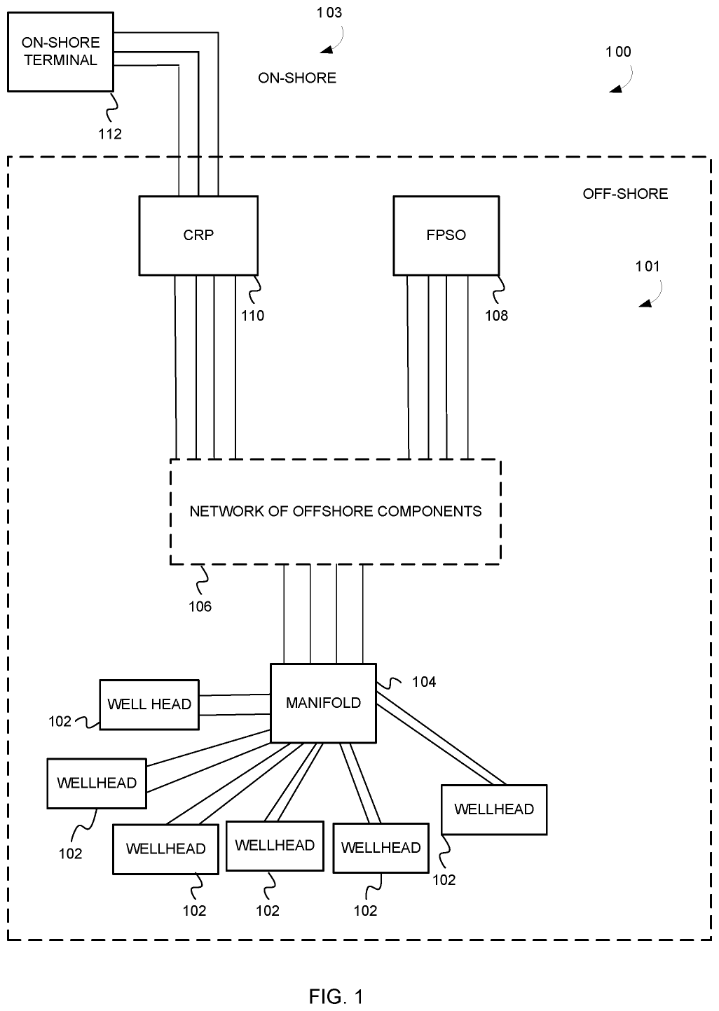

FIG. 1 is a block diagram illustrating an example production environment. The production environment 100 may include any equipment suitable for producing, storing, and transporting hydrocarbons. The example production environment 100 may include an offshore portion 101 and an onshore portion 103. In the offshore portion 101, a plurality of well heads 102 may be connected to a manifold 104. Each well head 102 may have a plurality of connections to the manifold 104. For example, each well head 102 may include tubulars connecting an annulus to the manifold 104 and production tubing to the manifold 104. Although FIG. 1 shows a single cluster of well heads, the production environment 100 may include any suitable number of offshore wellhead clusters.

Each of the wellheads 102 may sit atop a wellbore and may be connected to various tubulars, gauges, valves, and other components in and about the wellbore. Additionally, the wellheads 102 may be connected to each other. A surface controlled subsurface safety valve (SCSSV) (not shown in FIG. 1) may reside in each wellbore. A control system (not shown in FIG. 1) may automatically close the SCSSV in response to conditions that could cause equipment problems and safety issues (as discussed above). Some implementations predict when the SCSSV may automatically close and transmit notifications indicating impending well shut-ins. In response to the notifications, systems and/or operators may be able to avoid well shut-ins, thereby maintaining production and avoiding post-shut-in delays.

The manifold 104 may be connected to a network of offshore components 106 which may be connected to a floating production storage and offloading unit (FPSO) 108 and a control riser platform (CRP) 110. The network of offshore components 106 may include components such as well head manifolds, pipelines end manifolds, UDHs, and any other suitable components for producing hydrocarbons from offshore wells. The control riser platform 110 may be connected to an onshore terminal 112.

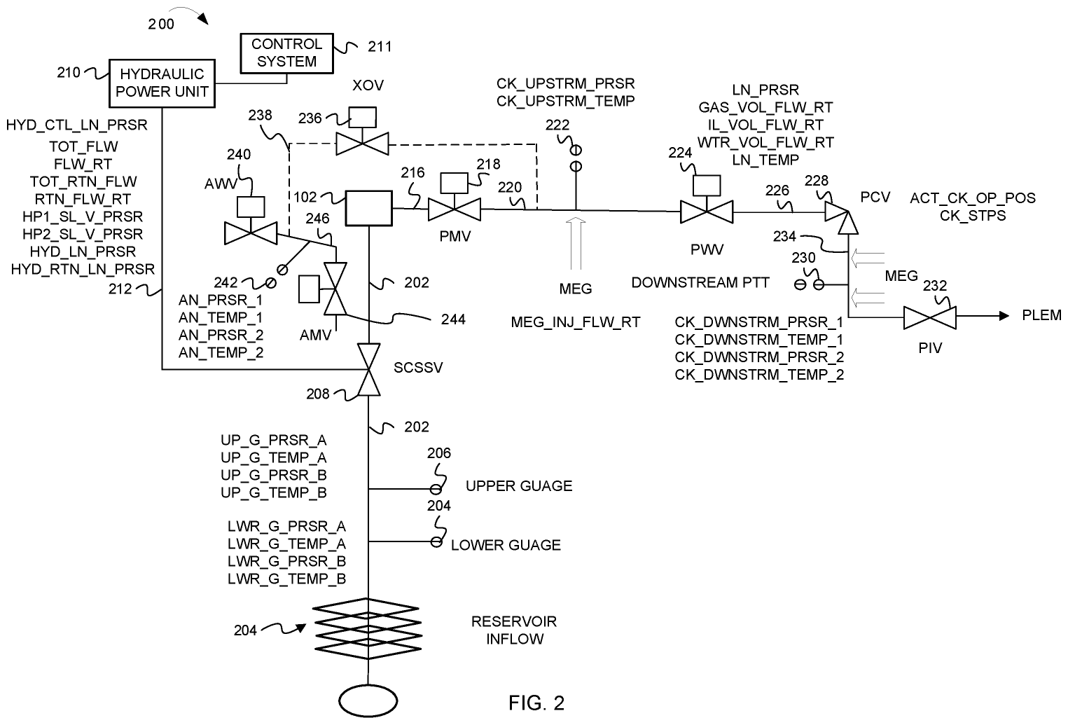

FIG. 2 is a block diagram representing an example fluid network for a well. In some implementations, the fluid network of FIG. 2 may be utilized in the production environment of FIG. 1. For example, each of the wellheads 102 (shown in FIG. 1) may be connected to an instance of the fluid network 200 and all instances of the fluid network 200 may be interconnected.

The fluid network 200 may include production tubing 202 configured to facilitate production of hydrocarbons from a reservoir 204. A lower gauge 204 and upper gauge 206 may be connected to the production tubing 202. The lower and upper gauges may be configured to detect temperature, pressure, flow, and any other suitable properties in the production tubing 202. An SCSSV 208 may control flow in the production tubing 202. The SCSSV 208 may be controlled using hydraulic pressure via a hydraulic line 212 from a hydraulic supply 210. In some implementations, the SCSSV 208 remains open when the hydraulic supply 210 maintains a given hydraulic pressure. The SCSSV 208 may close when hydraulic pressure falls below the given hydraulic pressure. A control system 211 may reduce the hydraulic pressure to close the SCSSV 208 in response to detecting conditions that may lead to equipment problems and/or safety issues. The control system 211 may detect such conditions based on information from the sensors described herein. Upon closing the SCSSV 208, production from the reservoir 204 may cease. The hydraulic supply 210 and/or the control system 211 may be located remote from the wellhead 102, such as in the CRP 110. The hydraulic supply 210 and/or the hydraulic line may include components (such as sensors, valves, controllers, etc.) that provide information shown in Table 1.

TABLE 1

| Sample Tag | Measured Property |
|---|---|
| TOT_FLW | HP Hyd. Total Flow (Itr) |
| FLW_RT | HP Hyd. Flow Rate (LPM) |
| TOT_RTN_FLW | HP Hyd. Total Return Flow |
| RTN_FLW_RT | HP Hyd. Return Flow Rate |
| HP1_SL_V_PRSR | HP1 Selector Valve Pressure |
| HP2_SL_V_PRSR | HP2 Selector Valve Pressure |
| HYD_LN_PRSR | Well specific hydraulic line pressure at seabed |
| HYD_RTN_LN_PRSR | Well specific hydraulic return line pressure |
| HYD_CTL_LN_PRSR | Hydraulic Control Line Pressure |

In Table 1 and the other tables herein, each row includes a sample tag and a measured property. For example, the sample tag AR1DEV1 may indicate a wellhead (see FIG. 1) from which the sensor sample was taken and FM3FQ may indicate a property that was measured such as a total flow of hydraulic fluid in the hydraulic line 212. In the tags described herein: P may indicate pressure; T may indicate temperature; Q may indicate flow rate; G may indicate gas. Hence, FM3FQ may indicate a flow rate. However, any suitable indicia may be used to indicate properties measured by the sensors. In some implementations, the hydraulic pressures may compensate for ambient depth. Some implementations utilize the measurements from Table 1 to predict an automatic closure of the SCSSV 208 (as further described herein).

The upper and lower gauges 204 and 206 may provide information shown in Table 2.

TABLE 2

| Sample Tag | Measured Property |
|---|---|
| UP_G_PRSR_A | Upper Gauge Pressure A |
| UP_G_TEMP_A | Upper Gauge Temperature A |
| UP_G_PRSR_B | Upper Gauge Pressure B |
| UP_G_TEMP_B | Upper Gauge Temperature B |
| LWR_G_PRSR_A | Lower Gauge Pressure A |
| LWR_G_TEMP_A | Lower Gauge Temperature A |
| LWR_G_PRSR_B | Lower Gauge Pressure B |
| LWR_G_TEMP_B | Lower Gauge Temperature B |

Some implementations utilize the measurements from Table 2 to predict an automatic closure of the SCSSV 208 (as further described herein).

Above the SCSSV 202, the production tubing 202 may connect to a manifold 214. A tubular may connect the manifold to a production master valve 218. A tubular 220 may connect the production master valve 218 with a production wing valve 224. An upstream pressure and temperature transmitter 222 may monitor temperature, pressure, flow, or any other suitable property of the tubular 220. The tubular 220 may include a port into which mono ethylene glycol may be introduced. The upstream pressure and temperature transmitter 222 may provide the following information shown in Table 3:

TABLE 3

| Sample Tag | Measured Property |
|---|---|
| MEG_INJ_FLW_RT | MEG Injection Flow Rate |
| CK_UPSTRM_PRSR | Choke Upstream Pressure |
| CK_UPSTRM_TEMP | Choke Upstream Temperature |

Some implementations utilize the measurements from Table 3 to predict an automatic closure of the SCSSV 208 (as further described herein).

The production wing valve 224 may be connected to a production choke valve 228 via a tubular 226. The production choke valve 228 may be connected to a production isolation valve 232 and a tubular 234. The tubular 234 may include gauges 230 which may measure temperature, flow, pressure, or any other properties. The gauges 230 may measure the properties (such as temperature, flow, and pressure) related to injection of mono ethylene glycol into the tubular 234 flowing.

The production isolation valve 232 may be connected to a pipeline and manifold (not shown). The tubing 234 may include one or more ports into which mono ethylene glycol may be injected. The gauges 230 or other components may provide the following information shown in Table 4.

TABLE 4

| Sample Tag | Measured Property |
|---|---|
| CK_DWNSTRM_PRSR_1 | Choke Downstream Pressure (CDP) |
| CK_DWNSTRM_TEMP_1 | Choke Downstream Temperature |
| CK_DWNSTRM_PRSR_2 | Choke Downstream Pressure |
| CK_DWNSTRM_TEMP_2 | Choke Downstream Temperature |

Some implementations utilize the measurements from Table 4 to predict an automatic closure of the SCSSV 208 (as further described herein).

In some implementations, one or more sensors and/or components in the tubular 226 connecting the production wing valve 224 with the production choke valve 228 measure the properties shown in Table 5. For example, the gauges 230 may provide the information shown in Table 5.

TABLE 5

| Sample Tag | Measured Property |
|---|---|
| LN_PRSR | Line Pressure |
| GAS_VOL_FLW_RT | Gas Vol Flow Rate (Standard condition) |
| OIL_VOL_FLW_RT | Oil Vol Flow Rate (Std. Condition) |
| WTR_VOL_FLW_RT | Water Vol Flow Rate |
| LN_TEMP | Line Temperature |

Some implementations utilize the measurements from Table 5 to predict an automatic closure of the SCSSV 208 (as further described herein).

In some implementations, there are one or more sensors and/or components in or about the production choke valve 228 that measure the properties shown in Table 6.

TABLE 6

| Sample Tag | Measured Property |
|---|---|
| ACT_CK_OP_POS | Actual Choke Opening Position (in percentage) |
| CK_STPS | Choke Steps |

Some implementations utilize the measurements from Table 6 to predict an automatic closure of the SCSSV 208 (as further described herein).

The fluid network 200 also may include an annular master valve 244 connected to an annular wing valve 240 via the tubular 246. The tubular 246 may include gauges 242, which may detect temperature, pressure, flow, or other properties. The tubular 246 also may be connected to a crossover valve 236 via a tubular 238. The tubular 238 also may connect the crossover valve 236 to the tubular 220. The gauges 242 may measure properties in the anulus and may provide the information in Table 7.

TABLE 7

| Sample Tag | Measured Property |
|---|---|
| AN_PRSR_1 | Annulus Pressure |
| AN_TEMP_1 | Annulus Temperature |
| AN_PRSR_2 | Annulus Pressure |
| AN_TEMP_2 | Annulus Temperature |

Some implementations utilize the measurements from Table 7 to predict an automatic closure of the SCSSV 208.

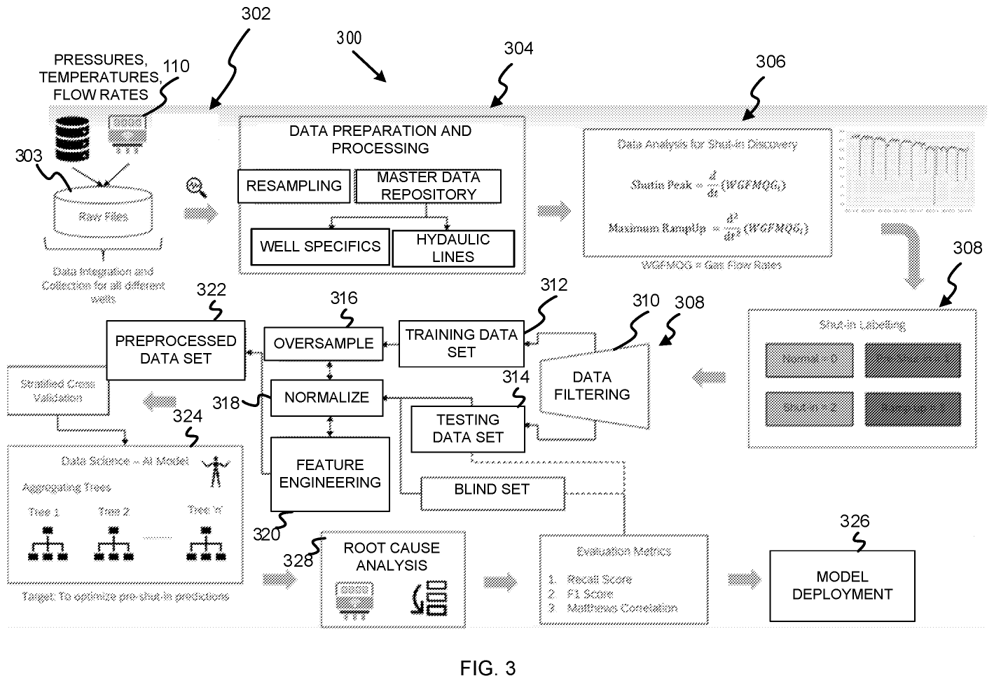

FIG. 3 is a process diagram showing an example process for training and utilizing a learning machine to control an SCSSV in a wellbore. In some implementations, the process 300 may be performed by the control system 211. The control system 211 may include any number of computing devices configured for performing the operations described herein. In other implementations, the process may be performed by any suitable components including software and/or hardware (such as one or more distributed computer systems). In FIG. 3, a process 300 begins at phase 302 where the control system 211 may collect well data 303. The well data 303 may include sensor samples from the sensors 110. The well data 303 may include pressure sensor samples, temperature sensor samples, flow rate sensor samples, and other historical information about the well system 100. The well data 303 also may include information (such as sensor readings) from other well systems.

Phases 304, 306, and 308 perform operations for creating training data for training a learning machine to predict SCSSV closures. At phase 304, the control system 211 may prepare and process the well data 303. In this phase, control system 211 may resample the well data 303. For example, different sensors may record sensor samples at different frequencies, so different sensors may have recorded a different number of samples in a time period. Resampling the well data 303 may change the number of samples associated with each sensor.

At phase 306, the computer system may analyze the well data 303 to identify times at which the SCSSV 114 was automatically closed. Some implementations may detect an SCSSV closure based on rates of change for specific independent variables. An independent variable may be based on one or more sensor samples in the well data 303.

In some implementations, the following equation (Equation 1) indicates a shut-in peak:

$$\frac{d x}{d t} ( GAS\_VOL \_FLW \_RT ) \qquad ( 1 )$$

GAS_VOL_FLW_RT may be a tag that indicates gas volume flow rate under standard conditions (as noted above—for example, see Table 5).

Similarly, the process may identify times at which SCSSV was turned on after closure. In some implementations, the following equation (Equation 2) indicates a maximum ramp-up:

$$\frac{{d}^{2}}{d {t}^{2}} ( GAS\_VOL \_FLW \_RT ) \qquad ( 2 )$$

Hence, at the conclusion of phase 306, the control system 211 has identified SCSSV closure and restart times in the well data 303.

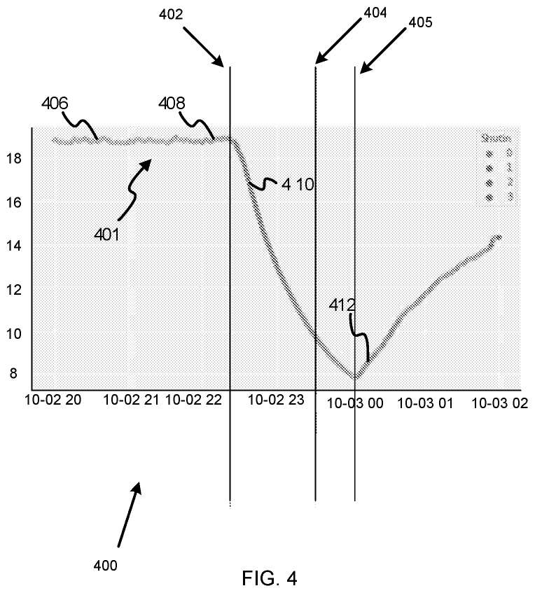

During phase 308, the control system 211 may label the well data 303. As noted, some implementations create training data and testing data by labeling independent variables based on various criteria. For example, each sensor sample in the well data 303 may be labeled based on when the sensor sample was recorded in relation to an SCSSV closure. FIG. 4 shows how some implementations may label sensor samples.

FIG. 4 is a graph showing labeled sensor samples. In FIG. 4, a graph 400 includes a curve 401 including sensor samples (i.e., independent variables) plotted over time. Each sensor sample may relate to an independent variable value, such as a gas volume flow rate (GAS_VOL_FLW_RT) indicated in a sensor sample (for example as described with reference to FIG. 2).

In FIG. 4, a first vertical line indicates a closure time 402 at which the SCSSV 114 was closed. A second vertical line indicates a reporting time 404 at which the SCSSV closure was reported. The reporting time 404 indicates when other components in the well system 100 learn of the SCSSV closure—i.e., a time that other components believe the SCSSV closure occurred.

Each sensor sample may be labeled based on its temporal relationship to the SCSSV closure time 402 or to a restart time 405. In the curve 401, the sensor samples 406 may be labeled as “normal” because they were sampled more than one hour prior to the SCSSV closure time 402. The sensor samples 408 may be labeled as “pre-closure” because they were sampled within one hour of the SCSSV closure time 402. The sensor samples 410 may be labeled as “closure” samples because they were sampled while the SCSSV 114 was closed. The sensor samples 412 may be labeled “restart” because they were sampled after the SCSSV 114 was opened (i.e., after the restart time 405).

The labeled data may include numerous curves including sensor samples labeled in the same fashion as the curve 401. In some implementations, a more granular labeling system may be utilized. For example, there are maybe a greater number of labels to indicate a greater number of time periods from the closure time 402 and the restart time 404. For example, in some implementations, the pre-closure labels may include six different labels indicating the following time intervals: from 120 to 91 minutes before SCSSV closure, from 90 to 61 minutes before SCSSV closure, from 60 to 31 minutes before SCSSV closure, from 30 to 21 minutes before SCSSV closure, from 20 to 11 minutes before SCSSV closure, and 10 minutes or less to SCSSV closure. Some implementations may utilize any suitable labeling system to create the training data set.

Referring back to FIG. 3, the process 300 continues at phase 308. At phase 308, the control system 211 may apply a filter 310 to the labeled data to create a training data set 312 and a testing data set 314. The filter 310 may remove all sensor samples except those labeled as normal and pre-closure to form the training data set 312 and the testing data set 314.

At phase 316, control system 211 may perform oversampling in the training data set 312. For example, the control system 211 may modify the training data set 312 to include significantly more sensor samples that are labeled as pre-closure than sensor samples that are labeled as normal. In the training data set 312, the labeled sensor samples may be referred to as features (aka independent variables) that will be input into a learning machine during a process for training the learning machine.

At phase 318, the control system 211 may normalize the testing data set 314.

At phase 320, the control system 211 may perform feature engineering. For example, the control system 211 may reduce the number of features (independent variables), add features, modify labels, or perform other operations on the features to enhance performance or efficiency of the learning machine.

At phase 322, the control system 211 may create a preprocessed dataset with which to train one or more learning machines. The preprocessed data set may be a result of the oversampling, normalization, and feature engineering phases (described above).

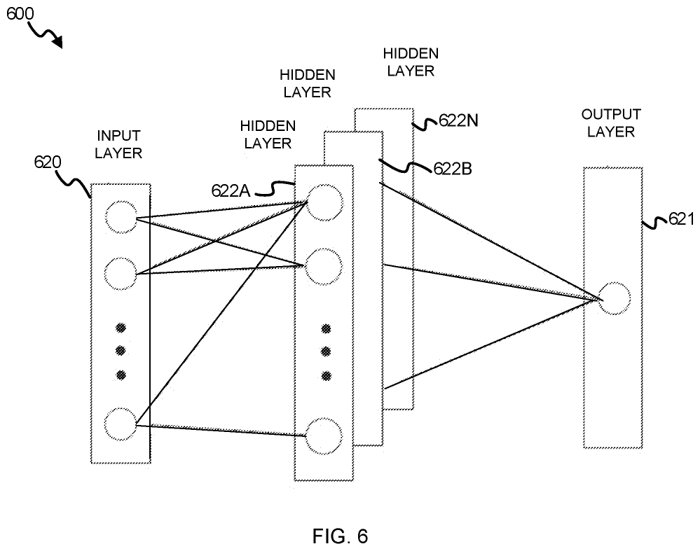

At phase 324, the control system 211 may create one or more learning machines and train them using the final version of the training data set, such as a portion of the preprocessed data set created at phase 322. As described herein, the training data set may include sensor samples that have been labeled as normal or pre-closure. The learning machines may include any suitable machine learning model, such as a generative model, linear regression model, logistic regression model, tree-based model, or any other suitable model. The learning machines may utilize neural networks or any other components to implement any of the machine learning models (see discussion of FIG. 6). During training, the one or more learning machines may process the labeled training data set and make predictions about when an SCSSV closure will occur. For example, the learning machine may predict when an SCSSV closure may occur based on one or more sensor samples in the training data set. For incorrect predictions, the learning machines may update weights, biases, and/or other aspects of a machine learning model to improve the likelihood of producing a correct prediction of the SCSSV closure time.

After the control system 211 trains the learning machine, the process may proceed to phase 326 where the learning machine is deployed in the field. When deployed, the learning machine may make predictions about SCSSV closures based on sensor readings that indicate conditions in the wellbore 102. The learning machine may receive real-time or periodic readings from the sensors 110, where the sensor readings are independent variables input into a trained machine learning model. Based on the sensor readings, the control system 211 may make predictions about an SCSSV closure. In some instances, the learning machine may indicate that no SCSSV closure is imminent. In other instances, the learning machine may output an estimated SCSSV closure time. In some instances, the control system 211 may transmit a notification about the impending SCSSV closure time. The notification may be intended for a person who may take action to avoid the SCSSV closure or for machine components that may take action to avoid the SCSSV closure.

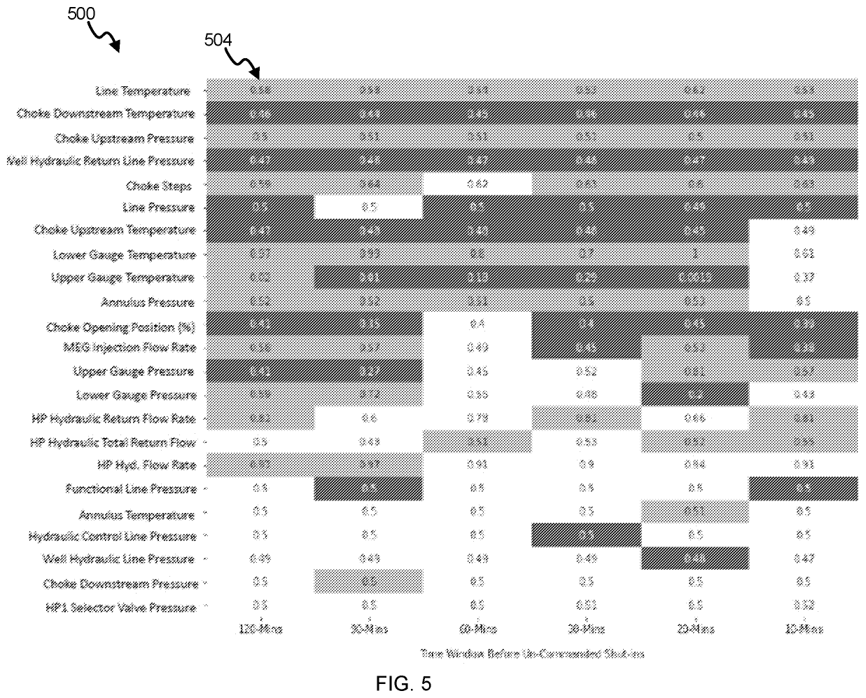

Separately, the control system 211 also may perform root cause analysis to determine which parameters may most heavily contribute to an SCSSV closure. At phase 328, the control system 211 performs a root cause analysis. FIG. 5 is a chart showing parameters and their relationship to an SCSSV closure. In FIG. 5, a chart 500 includes twenty-three rows 502 and five columns 504. Each row 502 represents an independent variable from the training data set. As noted above, each independent variable may represent a set of parameters relating to conditions in the wellbore 102. For example, the top row 502 includes line temperature, and the next row includes choke downstream temperature.

Each column 504 in the chart 500 includes values associated with the independent variable at times before an SCSSV closure. For example, in the top row, values for the line temperature include 0.58 at 120 minutes before SCSSV closure, 0.58 at 90 minutes before SCSSV closure, 0.54 at 60 minutes before SCSSV closure, 0.53 at 30 minutes before SCSSV closure, 0.62 at 20 minutes before SCSSV closure, and 0.53 at 10 minutes before SCSSV closure. The times before SCSSV closure are represented at the bottom of each column. In FIG. 5, from left to right, the times include 120 minutes, 90 minutes, 60 minutes, 30 minutes, and 20 minutes. Each value in each column indicates a probability that the independent variable may behave differently before an SCSSV closure. For example, in the top row, LN_TEMP has a 58% chance of changing 120 minutes before an SCSSV closure. Values that are lightly shaded indicate data points that may have positive significance. Values that are darkly shaded represent data points that may have negative significance. Unshaded values may be non-significant.

The chart 500 indicates that the most significant data points may be well hydraulic return line pressure, choke downstream temperature, choke upstream temperature, and line temperature. Other data points to review may include choke steps, choke opening position percentage, lower gauge temperature, anulus pressure, line pressure, and lower gauge pressure. Non-significant data points may include selector valve pressure, choke downstream pressure, choke downstream pressure, annulus temperature, and hydraulic control line pressure.

Based on the root cause analysis, the control system 211 may take measures to alter one or more of the independent variables identified as having positive significance. By altering these independent variables, the control system 211 may avoid an SCSSV closure.

The discussion continues with some example aspects that may be used in connection with learning machines described herein. FIG. 6 is a conceptual diagram showing an example neural network. In FIG. 6, a neural network 600 may be used to implement one or more of the machine learning models used in predicting an SCSSV closure time. Hence, any of the learning machines described herein may include a neural network similar to the neural network 600.

The neural network 600 may include an input layer 620 configured to receive features (such as the data points described with reference to FIG. 3 and Equations 1 and 2), well sensor samples, or any other data indicating conditions in the wellbore 102. The neural network 600 also may include hidden layers 622a, 622b, through 622n. The hidden layers 622a, 622b, through 622n may include “n” number of hidden layers, where “n” is an integer greater than or equal to one. The number of hidden layers may include as many layers as needed for the given application. The neural network 600 also may include an output layer 621 that may provide an output resulting from the processing performed by the hidden layers 622a, 622b, through 622n. For example, the output layer 621 may provide an SCSSV closure time.

The neural network 600 may be a multi-layer neural network of interconnected nodes. Each node may represent a piece of information. Information associated with the nodes may be shared among the different layers. Each layer may retain information as information is shared and processed. In some implementations, the neural network 600 may include a feed-forward network in which no feedback connections feed information back into the neural network 600. In some implementations, the neural network 600 may include a recurrent neural network, which may have loops that allow information to be carried across nodes while reading input.

Information may be exchanged between nodes through node-to-node interconnections between the various layers. Nodes of the input layer 620 may activate a set of nodes in the first hidden layer 622a. For example, as shown, each of the input nodes of the input layer 620 may be connected to each of the nodes of the first hidden layer 622a. The nodes of the first hidden layer 622a may transform the information of each input node by applying activation functions to the input node information. The information derived from the transformation may then be passed to and may activate the nodes of the next hidden layer 622b, which may perform their own designated functions. Example functions include convolutional, up-sampling, data transformation, and/or any other suitable functions. The output of the hidden layer 622b may then activate nodes of the next hidden layer, and so on. The output of the last hidden layer 622n may activate one or more nodes of the output layer 621, at which an output is provided. In some cases, while nodes in the neural network 600 are shown as having multiple output lines, a node may have a single output and all lines shown as being output from a node represent the same output value.

In some cases, each node or interconnection between nodes may have a weight that is a set of parameters derived from the training of the neural network 600. Once the neural network 600 is trained, it may be referred to as a trained neural network, which may be used to classify one or more activities. For example, an interconnection between nodes may represent a piece of information learned about the interconnected nodes. The interconnection may have a tunable numeric weight that may be tuned (e.g., based on the training dataset), allowing the neural network 600 to be adaptive to inputs and able to learn as more and more data is processed.

The neural network 600 may be pre-trained to process the features from the data in the input layer 620 using the different hidden layers 622a, 622b, through 622n in order to provide the output through the output layer 621. In some cases, the neural network 600 may adjust the weights of the nodes using a training process called backpropagation. A backpropagation process may include a forward pass, a loss function, a backward pass, and a weight update. The forward pass, loss function, backward pass, and parameter/weight update may be performed for one training iteration. The process may be repeated for a certain number of iterations for each set of training data until the neural network 600 is trained well enough so that the weights of the layers are accurately tuned.

To perform training, a loss function may be used to analyze errors in the output. Any suitable loss function definition may be used, such as a Cross-Entropy loss. Another example of a loss function includes the mean squared error (MSE), defined as

E_total=Σ(½(target-output)∧2). The loss may be set to be equal to the value of E_total.

The loss (or error) will be high for the initial training data since the actual values will be much different than the predicted output. The goal of training is to minimize the amount of loss so that the predicted output is the same as the training output. The neural network 600 may perform a backward pass by determining which inputs (weights) most contributed to the loss of the network and may adjust the weights so that the loss decreases and is eventually minimized.

The neural network 600 may include any suitable deep network. One example includes a Convolutional Neural Network (CNN), which includes an input layer and an output layer, with multiple hidden layers between the input and out layers. The hidden layers of a CNN may include a series of convolutional, nonlinear, pooling (for down sampling), and fully connected layers. The neural network 600 may include any other deep network other than a CNN, such as an autoencoder, Deep Belief Nets (DBNs), Recurrent Neural Networks (RNNs), or others.

As understood by those of skill in the art, machine-learning based classification methods may vary depending on the desired implementation. For example, machine-learning classification schemes may utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to a Stochastic Gradient Descent Regressor, a Passive Aggressive Regressor, etc.

Machine learning classification models also may be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine learning models may employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

Some implementations may include any suitable components to facilitate generative machine learning. The neurons, connections, weights, biases, activation functions, loss functions, back propagation methodologies, and other concepts described herein may be modified, enhanced, or excluded depending on the desired implementation. Other concepts relating to machine learning may have been omitted from this discussion but nevertheless may be utilized to achieve the implementations described in this disclosure.

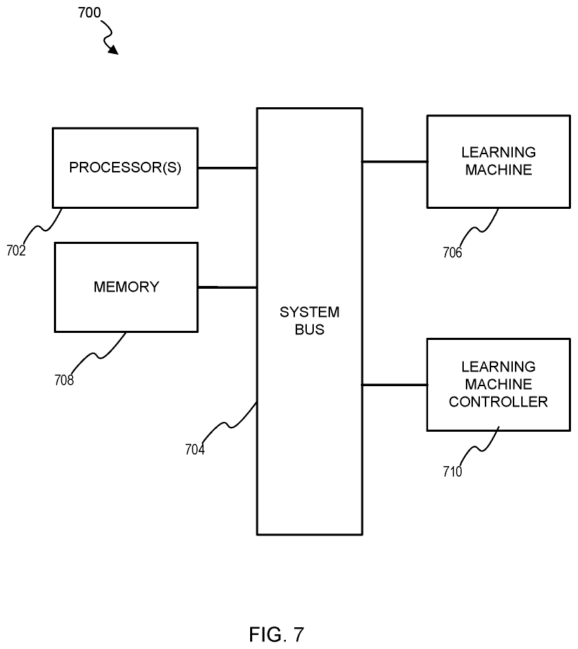

FIG. 7 is a block diagram illustrating a computer system, according to some implementations. In FIG. 7, a computer system 700 may include one or more processors 702 connected to a system bus 704. The system bus 704 may be connected to memory 708. The memory 708 may include any suitable memory random access memory (RAM), non-volatile memory (e.g., magnetic memory device), and/or any device for storing information and instructions executable by the processor(s) 702.

In some implementations, the computer system 700 includes additional peripheral devices. For example, in some implementations, the computer system 700 includes multiple external multiple processors. In some implementations, any of the components can be integrated or subdivided.

The computer system 700 also may include a learning machine 706 and learning machine controller 710. The learning machine 706 may implement the functionalities described herein. In some implementations, the learning machine 706 includes a neural network 600 that performs operations for machine learning described herein. For example, the learning machine 706 may include program instructions that implement one or more methods of predicting closure of an SCSSV (as described herein). The computer system 700 also may include the learning machine controller that may perform operations relating to labeling well data, training the learning machine, root cause analysis, and other operations.

Any component of the computer system 700 can be implemented as hardware, firmware, and/or machine-readable media including computer-executable instructions for performing the operations described herein. For example, some implementations include one or more non-transitory machine-readable media including computer-executable instructions including program code configured to perform functionality described herein. Machine-readable media includes any mechanism that provides (e.g., stores and/or transmits) information in a form readable by a machine (e.g., a computer system). For example, tangible machine-readable media includes read only memory (ROM), random access memory (RAM), magnetic disk storage media, optical storage media, flash memory machines, etc. Machine-readable media also includes any media suitable for transmitting software over a network.

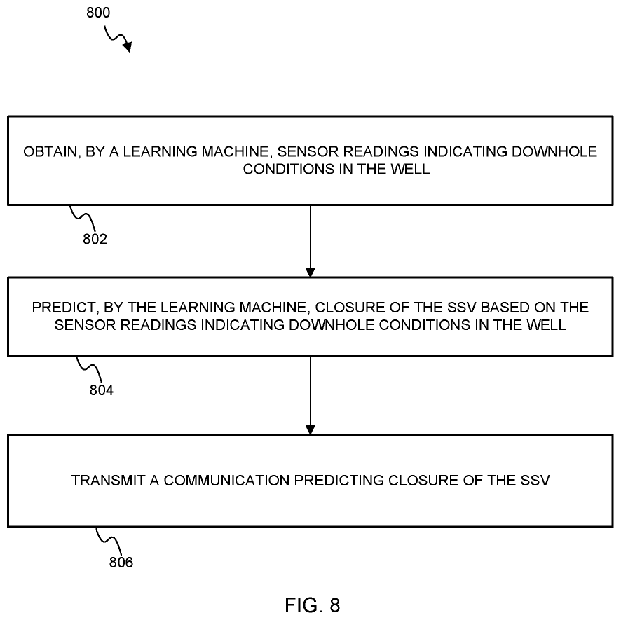

FIG. 8 is a flow diagram illustrating a method for predicting closure of an SCSSV. The SCSSV may be configured to shut-in a well and may not include any sensors. At block 802, a learning machine obtains sensor readings indicating downhole conditions in a well. At block 804, the learning machine may predict closure of the SCSSV based on the sensor readings indicating downhole conditions in the well. At block 806, a communication predicting closure of the SCSSV is transmitted.

FIGS. 1-8 and the operations described herein are examples meant to aid in understanding example implementations and should not be used to limit the potential implementations or limit the scope of the claims. Some implementations may perform additional operations, fewer operations, operations in parallel or in a different order, and some operations differently.

As used herein, a phrase referring to “at least one of” a list of items refers to any combination of those items, including single members. As an example, “at least one of: a, b, or c” is intended to cover: a, b, c, a-b, a-c, b-c, and a-b-c.

None of the implementations described herein may be performed exclusively in the human mind nor exclusively using pencil and paper. None of the implementations described herein may be performed without the computerized components described herein. For example, all implementations of the learning machine include computerized components.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described throughout. Whether such functionality is implemented in hardware or software depends upon the particular application and design constraints imposed on the overall system.

The hardware and data processing apparatus used to implement the various illustrative logics, logical blocks, modules and circuits described in connection with the implementations disclosed herein may be implemented or performed with a general purpose single- or multi-chip processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described herein. A general-purpose processor may be a microprocessor or any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more implementations, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, e.g., one or more modules of computer program instructions stored on a computer storage media for execution by, or to control the operation of, a computing device.

If implemented in software, the functions may be stored on or transmitted over as one or more instructions or code on a computer-readable medium. The processes of a method or algorithm disclosed herein may be implemented in a processor-executable instructions which may reside on a computer-readable medium. Computer-readable media includes both computer storage media and communication media including any medium that may be enabled to transfer a computer program from one place to another. Storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-Ray™ disc where disks usually reproduce data magnetically, while discs reproduce data optically with lasers. Combinations also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

Additionally, a person having ordinary skill in the art will readily appreciate, the terms “upper” and “lower” are sometimes used for ease of describing the Figures and indicate relative positions corresponding to the orientation of the Figure on a properly oriented page and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example process in the form of a flow diagram. However, some operations may be omitted and/or other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described should not be understood as requiring such separation in all implementations, and the described program components and systems may generally be integrated together in a single software product or packaged into multiple software products. Additionally, other implementations are within the scope of the following claims. In some cases, the actions recited in the claims may be performed in a different order and still achieve desirable results.

All implementations described herein relate to processes performed by computerized components including but not limited to hardware and software components. The description and claims do not cover implementations that are exclusively performed in the human mind or exclusively with pencil and paper.

### Example Clauses

Some implementations may include the following clauses.

Clause 1: A method for predicting closure of a subsurface safety valve (SCSSV) configured to shut-in a well without any sensors on the SCSSV, the method comprising: obtaining, by a learning machine, sensor readings indicating downhole conditions in the well; predicting, by the learning machine, closure of the SCSSV based on the sensor readings indicating downhole conditions in the well; and transmitting a communication predicting closure of the SCSSV.

Clause 2: The method of clause 1, further comprising: modifying, based on the conditions, one or more components that control gas flow in the well to prevent closure of the SCSSV.

Clause 3: The method of any one or more of clauses 1-2 further comprising: storing, in a sensor data repository, sensor samples captured by sensors in the well; labeling each of the sensor samples to create a training data set, the labels indicating that each respective sensor sample indicates normal well behavior or pre-shut-in behavior; training, using the training data set, the learning machine to identify pre-shut-in behavior in training data set.

Clause 4: The method of any one or more of clauses 1-3 further comprising: modifying the training dataset by oversampling the sensor data samples labeled to identify pre-shut-in behavior.

Clause 5: The method of any one or more of clauses 1-4 further comprising: identifying, in the training data set, certain of the sensor samples that contribute to the closure of the SCSSV.

Clause 6: The method of any one or more of clauses 1-5, wherein the prediction indicates closure of the SCSSV will occur one hour from a time of the prediction.

Clause 7: The method of any one or more of clauses 1-6 wherein the conditions in the well include flow rates inside the well.

Clause 8: One or more non-transitory machine-readable mediums including instructions that, when executed by one or more processors, predict closure of a subsurface safety valve (SCSSV) configured to shut-in a well without any sensors on the SCSSV, the instructions comprising: instructions to obtain, by a learning machine, sensor readings indicating downhole conditions in the well; instructions to predict, by the learning machine, closure of the SCSSV based on the sensor readings indicating downhole conditions in the well; and instructions to transmit a communication predicting closure of the SCSSV.

Clause 9: The one or more non-transitory machine-readable mediums of clause 8, the instructions further comprising: instructions to modify, based on the conditions, one or more components that control gas flow in the well to prevent closure of the SCSSV.

Clause 10: The one or more non-transitory machine-readable mediums of any one or more of clauses 8-9, the instructions further comprising: instructions to store, in a sensor data repository, sensor samples captured by sensors in the well; instructions to label each of the sensor samples to create a training data set, the labels indicating that each respective sensor sample indicates normal well behavior or pre-shut-in behavior; instructions to train, using the training data set, the learning machine to identify pre-shut-in behavior in training data set.

Clause 11: The one or more non-transitory machine-readable mediums of any one or more of clauses 8-10, the instructions further comprising: instructions to modify the training dataset by oversampling the sensor data samples labeled to identify pre-shut-in behavior.

Clause 12: The one or more non-transitory machine-readable mediums of any one or more of clauses 8-11 further comprising: instructions to identify, in the training data set, certain of the sensor samples that contribute to the closure of the SCSSV.

Clause 13: The one or more non-transitory machine-readable mediums of any one or more of clauses 8-12, wherein the prediction indicates closure of the SCSSV will occur one hour from a time of the prediction.

Clause 14: The one or more non-transitory machine-readable mediums of any one or more of clauses 8-13, wherein the conditions in the well include flow rates inside the well.

Clause 15: An apparatus comprising: one or more processors; one or more non-transitory machine-readable mediums including instructions that, when executed by the one or more processors, predict closure of a subsurface safety valve (SCSSV) configured to shut-in a well without any sensors on the SCSSV, the instructions including instructions to obtain, by a learning machine, sensor readings indicating downhole conditions in the well; instructions to predict, by the learning machine, closure of the SCSSV based on the sensor readings indicating downhole conditions in the well; and instructions to transmit a communication predicting closure of the SCSSV

Clause 16: The apparatus of clause 15 further comprising: instructions to modify, based on the conditions, one or more components that control gas flow in the well to prevent closure of the SCSSV.

Clause 17: The apparatus of any one or more of clauses 15-16, the instructions further comprising: instructions to store, in a sensor data repository, sensor samples captured by sensors in the well; instructions to label each of the sensor samples to create a training data set, the labels indicating that each respective sensor sample indicates normal well behavior or pre-shut-in behavior; instructions to train, using the training data set, the learning machine to identify pre-shut-in behavior in training data set.

Clause 18: The apparatus of any one or more of clauses 15-17, the instructions further comprising: instructions to modify the training dataset by oversampling the sensor data samples labeled to identify pre-shut-in behavior.

Clause 19: The apparatus of any one or more of clauses 15-18 further comprising: instructions to identify, in the training data set, certain of the sensor samples that contribute to the closure of the SCSSV.

Clause 20: The apparatus of any one or more of clauses 15-19, wherein the prediction indicates closure of the SCSSV will occur one hour from a time of the prediction.

What is claimed is:

1. A method for predicting closure of a subsurface safety valve (SCSSV) configured to shut-in a well without any sensors on the SCSSV, the method comprising:
obtaining, by a learning machine, sensor readings indicating downhole conditions in the well;
predicting, by the learning machine, closure of the SCSSV based on the sensor readings indicating downhole conditions in the well; and
transmitting a communication predicting closure of the SCSSV.

2. The method of claim 1 further comprising:
modifying, based on the conditions, one or more components that control gas flow in the well to prevent closure of the SCSSV.

3. The method of claim 1 further comprising:
storing, in a sensor data repository, sensor samples captured by sensors in the well;
labeling each of the sensor samples to create a training data set, the labels indicating that each respective sensor sample indicates normal well behavior or pre-shut-in behavior;
training, using the training data set, the learning machine to identify pre-shut-in behavior in training data set.

4. The method of claim 3 further comprising:
modifying the training dataset by oversampling the sensor data samples labeled to identify pre-shut-in behavior.

5. The method of claim 3 further comprising:
identifying, in the training data set, certain of the sensor samples that contribute to the closure of the SCSSV.

6. The method of claim 1, wherein the prediction indicates closure of the SCSSV will occur one hour from a time of the prediction.

7. The method of claim 1 wherein the conditions in the well include flow rates inside the well.

8. One or more non-transitory machine-readable mediums including instructions that, when executed by one or more processors, predict closure of a subsurface safety valve (SCSSV) configured to shut-in a well without any sensors on the SCSSV, the instructions comprising:
instructions to obtain, by a learning machine, sensor readings indicating downhole conditions in the well;
instructions to predict, by the learning machine, closure of the SCSSV based on the sensor readings indicating downhole conditions in the well; and
instructions to transmit a communication predicting closure of the SCSSV.

9. The one or more non-transitory machine-readable mediums of claim 8, the instructions further comprising:
instructions to modify, based on the conditions, one or more components that control gas flow in the well to prevent closure of the SCSSV.

10. The one or more non-transitory machine-readable mediums of claim 8, the instructions further comprising:
instructions to store, in a sensor data repository, sensor samples captured by sensors in the well;
instructions to label each of the sensor samples to create a training data set, the labels indicating that each respective sensor sample indicates normal well behavior or pre-shut-in behavior;
instructions to train, using the training data set, the learning machine to identify pre-shut-in behavior in training data set.

11. The one or more non-transitory machine-readable mediums of claim 10, the instructions further comprising:
instructions to modify the training dataset by oversampling the sensor data samples labeled to identify pre-shut-in behavior.

12. The one or more non-transitory machine-readable mediums of claim 10 further comprising:
instructions to identify, in the training data set, certain of the sensor samples that contribute to the closure of the SCSSV.

13. The one or more non-transitory machine-readable mediums of claim 8, wherein the prediction indicates closure of the SCSSV will occur one hour from a time of the prediction.

14. The one or more non-transitory machine-readable mediums of claim 8, wherein the conditions in the well include flow rates inside the well.

15. An apparatus comprising:
one or more processors;
one or more non-transitory machine-readable mediums including instructions that, when executed by the one or more processors, predict closure of a subsurface safety valve (SCSSV) configured to shut-in a well without any sensors on the SCSSV, the instructions including
instructions to obtain, by a learning machine, sensor readings indicating downhole conditions in the well,
instructions to predict, by the learning machine, closure of the SCSSV based on the sensor readings indicating downhole conditions in the well, and
instructions to transmit a communication predicting closure of the SCSSV.

16. The apparatus of claim 15, the instructions further comprising:
instructions to modify, based on the conditions, one or more components that control gas flow in the well to prevent closure of the SCSSV.

17. The apparatus of claim 15, the instructions further comprising:
instructions to store, in a sensor data repository, sensor samples captured by sensors in the well;
instructions to label each of the sensor samples to create a training data set, the labels indicating that each respective sensor sample indicates normal well behavior or pre-shut-in behavior;
instructions to train, using the training data set, the learning machine to identify pre-shut-in behavior in training data set.

18. The apparatus of claim 17, the instructions further comprising:
instructions to modify the training dataset by oversampling the sensor data samples labeled to identify pre-shut-in behavior.

19. The apparatus of claim 17 further comprising:
instructions to identify, in the training data set, certain of the sensor samples that contribute to the closure of the SCSSV.

20. The apparatus of claim 15, wherein the prediction indicates closure of the SCSSV will occur one hour from a time of the prediction.
